(19) United States
(12) Patent Application Publication
(10) Pub. No.: US 2007/0175583 A1
(43) Pub. Date: Aug. 2, 2007

(54) Technique for prestressing composite members and related apparatuses

(76) Inventor: Ayman S. Mosallam, Irvine, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/588,644

(22) Filed: Oct. 27, 2006

Related U.S. Application Data
(60) Provisional application No. 60/763,596, filed on Jan. 31, 2006.

(51) Int. Cl. B32B 37/00

(52) U.S. Cl. 156/307.1; 428/411.1

(57) ABSTRACT

Disclosed is a method for increasing and optimizing the structural performance of composite structural member for use as primary load-bearing members through the introduction of prestressing members to the structure. Prestressing may occur by either pre-tensioning or post-tensioning the reinforced polymer structure. The teachings of the present disclosure are useful in constructing structural elements of bridges, buildings, pipes, poles, and other common structural members, including pilings and plywood.

### RELATED APPLICATIONS

This application relates to and claims the priority date of U.S. Provisional Patent Application No. 60/763,596 filed on Jan. 31, 2006, which is hereby expressly incorporated by reference in its entirety.

### BACKGROUND

This present disclosure is related to structural composite systems, methods, and apparatuses for various applications. The two primary phases of composites are the matrix and the reinforcement. Nearly any matrix or reinforcement may be used depending on the desired characteristics of the composite, including strength, stiffness, acoustic response, damping, toughness, ductility, environmental durability and other engineering requirements. Composite matrix materials may include epoxy, phenolics, vinylester, polyester, or others. However, the choice of matrix material should not be limited to polymers and may include ceramic, metal and organic compounds. Reinforcements, which primarily refer to fibers, may take the form of continuous or discontinuous strands, rods, fabric, tapes, weaves and laminates; and may be made from metals, organic materials, synthetic materials or other suitable substances known to those skilled in the art. The present disclosure is not constrained by angle or direction, so that any geometric configuration may be internally and/or externally pre- or post-stressed, and may be used in, both large scale and small scale, structural and non-structural applications. As such, the technology is applicable but not limited to aerospace structures, space and aircraft surfaces, fuselages, wings, ailerons, platforms, bulkheads, flooring, marine platforms, ships and submarines, bridge decks, bridge girders and beams, structural profiles used in buildings including pultruded composites, columns and piles of different shapes, chimneys and pipes, tanks, silos, tunnels, and walls. The technology may also be extended to shafts, plates and bars, which are applicable to civil infrastructure, industrial applications, and sporting goods.

This present disclosure describes an innovative technique that increases and optimizes the performance of composite members, for use as primary load-bearing and non-load bearing elements, by the introduction of pre-stressing forces. Pre-stressing allows composites to be used more efficiently in the construction of sub- and super-structural elements of buildings, spacecraft, aircraft, ships, submarines, automobiles, tanks, trucks, containers, bridges, pipes, and poles. Pre-stressing is particularly suited for larger spans that are employed in major construction applications such as cantilevered bridge decks, deep sheet piles and foundations, poles and other structures. Pre-stressing may also be used to deliver improved acoustic performance, enhanced impact resistance, and superior environmental capabilities, which are characteristics that are particularly suited for naval and military applications.

### SUMMARY

Disclosed is a method for increasing and optimizing the performance of man-made and naturally occurring composite members through the introduction of pre-stressing elements. Pre-stressing may occur by either pre-tensioning the composite structure, post-tensioning the composite structure, or applying a combination of both methodologies to the composite structure. The teachings of the present disclosure are useful in constructing structural elements of aircraft, ships, buildings, bridges, pipes, poles, and other common structural members, including pilings and plywood. The teachings of the present disclosure may extend to the repair and rehabilitation of man-made composite structures and naturally occurring composite structures, such as bones and other organic systems.

Disclosed is a method of changing the stress profile of a composite member comprising the steps of providing composite member and providing at least one pre-stressing member, wherein the pre-stressing member is used to prestress the composite member.

Still further disclosed is a kit of parts for making a prestressed composite member comprising a composite matrix material, at least one reinforcement member, and at least one pre-stressing member, wherein the composite matrix material and the at least one reinforcement member are used to form a composite, and wherein the pre-stressing member is designed to prestress the composite member.

Yet further disclosed is a method for reducing construction costs comprising the step of substituting traditional building materials with prestressed composite members.

Disclosed still further is an improved wood, plywood or other wood-based product structurally upgraded by using a pre-stressing member, wherein the pre-stressing member is fixed to the wood-based product on one side, two sides, between the plies of the wood-based product, within the confines of the matrix, or combinations thereof.

Disclosed is a method of reducing construction costs with an improved wood-based building material comprising the step of treating a wood-based product with at least one pre-stressing member affixed to the wood, plywood or other wood-based product, wherein application of at least one pre-stressing member to the product modifies the stress profile of the product.

Disclosed is a method of making an improved wood-based building material comprising the steps of providing a wood-based medium, a laminating material and at least one pre-stressing member; and treating the wood-based medium with the laminating material and at least one pre-stressing member to form an improved wood-based medium, wherein the laminate contains at least one pre-stressing member and the treated medium exhibits a modified stress profile.

Disclosed is a method of making an improved wood-based building material comprising the steps of providing a wood-based medium and at least one pre-stressing member and treating the wood-based medium with the pre-stressing member to form an improved wood-based medium, which exhibits a modified stress profile.

Disclosed is an improved composite piling, sound wall, retaining wall, bearing wall, firewall and sea fence that is prestressed with pre-stressing elements such as internal or external strands or laminates, wherein the pre-stressing element modifies the stress profile of the composite piling.

Further disclosed is the information that the pre-stressing member may take the form of synthetic fibers, fabrics, tapes, weaves, laminas, laminates, cables, rods, netting, or combinations thereof, known to a person of ordinary skill in the art.

Further disclosed is the knowledge that pre-stressing members may be made of steel, aluminum, or other metals; natural fibers, such as flax, kenaf, hemp, or wood; synthetic fibers, such as E-glass, S-glass, aramid, carbon, graphite, silicon carbide, aluminum, boron, ultrahigh molecular weight polyethylene, polybenzoxazile (PBO), nylon, vectran, polybenzimidizole (PBI), vectra, dyneema, certran, and spectra; or other suitable pre-stressing implements known to those skilled in the art.

Finally, disclosed is a method by which the pre-stressing member is fixed or attached to the composite member by means of mechanical anchoring, adhesive bonding, or utilization micro-scale structures to improve grip. In turn, these practices are supplemented by certain physical phenomena such as thermal effects related to curing and the influence of magnetic fields, which may affect the magnitude and direction of stress.

### DRAWINGS

The above-mentioned features and objects of the present disclosure will become more apparent with reference to the following description taken in conjunction with the accompanying drawings wherein like reference numerals denote like elements and in which:

FIG. 1 shows an embodiment of the process of making one type of composite combining the matrix material and reinforcements to form individual composite lamina, which are rotated, stacked and bonded, or organized by other means know to the art, to produce a composite laminate.

FIG. 2A shows an embodiment of a sectional view of a typical prestressed composite beam with the pre-stressing members placed eccentrically.

FIG. 2B shows an embodiment of a side view of a typical prestressed composite beam that is simply supported on both ends and subject to a dead weight or applied load on the upper surface at the midpoint of the beam.

FIG. 2C shows an embodiment of a stress diagram illustrating the stress distribution on the typical prestressed composite beam as a function of section when the composite prestressed beam is loaded.

FIG. 3 shows an embodiment of a longitudinal cross section of a typical prestressed composite girder showing a method of pre-stressing the girder by affixing a tension retention device at the end of the pre-stressing members.

FIG. 4 shows an embodiment of a perspective view illustrating the process of pre-tensioning the fibers or cables in a typical prestressed composite member by stretching the pre-stressing members on heated drums in a curing chamber while the composite member cures.

FIG. 5 shows a perspective view of an embodiment illustrating the process of pre-tensioning pre-stressing members within a pre-cured composite members.

FIG. 6A shows a cross section of an embodiment of an improved plywood, which is prestressed on two sides.

FIG. 6B shows a perspective view of an embodiment of an improved plywood, which is prestressed.

FIG. 7 shows a perspective view of an embodiment of prestressed composite pilings.

### DETAILED DESCRIPTION

A composite member shall be defined as any material that is formed from the combination of matrix material and reinforcements and is used in structural and non-structural functions for civil, mechanical, aerospace, marine and construction applications. Matrix materials used in composite members serve to bind reinforcements together and transfer loads between reinforcements. Matrix materials are primarily made from polymers but may also consist of ceramic, metal or organic compounds. Reinforcements are the primary load carrying components in composite members. Reinforcements commonly refer to fibers but may take the form of continuous or discontinuous strands, rods, cables, fabric, tapes, weaves and laminates and may be made from metals, organic materials, and synthetic products.

Pre-stressing materials are any elements used to induce a substantial pre-stressing stress in composite members.

Pre-stressing shall be defined as pre-tensioning or post-tensioning but is extendable to pre-compressing or post-compressing.

The present disclosure improves upon the existing techniques of manufacturing composite members. The methods disclosed enhance the shear, flexural, axial, and impact strength, stiffness, creep performance, and decrease the initial and life-cycle costs associated with the production of load-bearing structural members. As applied to composite members, specifically pre-stressing allows the majority of load resistance to be overcome with the prestress rather than the reinforcement member of the composite member. Thus, a lower volume of reinforcement members are needed by a pre-stressed composite member to accomplish the same task when using conventional non pre-stressed design, which ultimately reduces cost, weight, and the volume of construction materials needed without sacrificing strength, stiffness, impact, toughness, and creep performance. Consequently, the present disclosure improves the performance of composite members by improving deflection under service loading conditions, saving cost and time, as well as, giving designers a superior set of tools.

While the scope of this disclosure is applicable to structural and non-structural applications in a variety of industries, one particular usage of this technology has significant merit for the construction industry. Although building materials other than concrete and steel, including composites, are currently used for similar purposes, composite materials that used carbon fibers as load bearing elements are often cost prohibitive for many applications. Conversely, cheaper reinforcement materials, such as E-glass, S-glass, aramid, and other fibrous materials, suffer from weaknesses that have made them impracticable in many construction, as well as aerospace, marine and military situations. For example, E-glass reinforced composites have a low modulus of elasticity, which results in larger deflections when loaded. Consequently, an un-prestressed E-glass reinforced composite member is impracticable for many applications, such as for use as the structural elements of bridges. Similar issues of impracticability were common detriments to the widespread use of composites in large span applications, such as bridges, wings, and decks, prior to the teachings of the present disclosure. Moreover, many of these composite materials experience increased creep as a function of exposure to higher stress, temperature and other environmental conditions, making un-prestressed composites members completely unsuitable for structural applications. The present disclosure addresses the above weaknesses by increasing the load carrying capacity of composite members and reducing the number of reinforcements required to achieve certain levels of strength and stiffness, which will results in additional cost savings.

Due to their inherent viscoelastic nature, composite members often suffer from creep deformation and creep rupture under heavy and sustained service loads. For this reason, a composite member must have a large cross section and heavy reinforcement content to impart the same strength as a traditional material, such as steel. Thus, without pre-stressing, many composites are poor substitutes for traditional building materials because they have limitations that make their use inappropriate, due to requirements of oversized cross sections, or uneconomical, due to excessive cost.

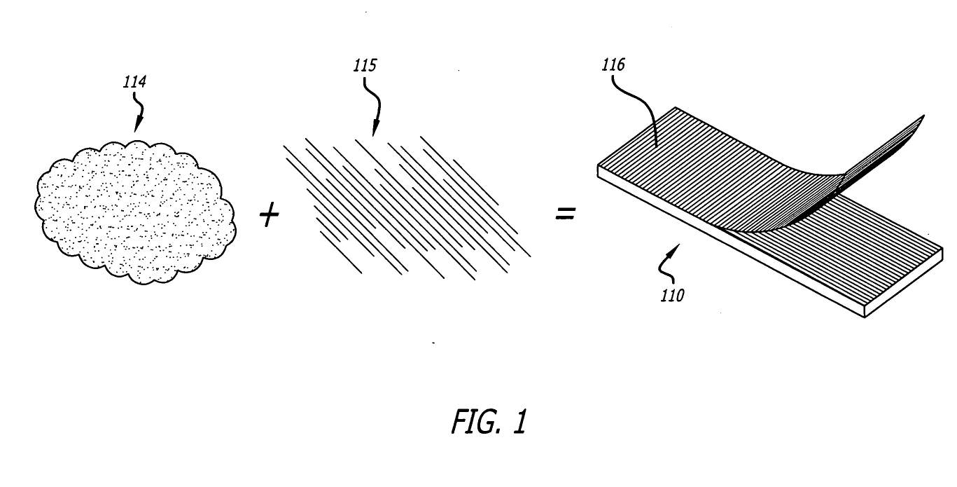

Turning now to embodiments represented in FIG. 1, composite member 110 is made from the mixture of matrix material 114 and reinforcement members 115 to form composite lamina 116. Composite lamina 116 may be rotated, stacked and bonded, or combined by other means know to the art, to produce composite member 110. The present disclosure expressly contemplates use of both thermoset and thermoplastic resins, as well as ceramic, metal, organic, i.e. naturally occurring other than man-made, or other compounds known to the art for use as composite matrix material 114. Examples of thermoset polymeric resins contemplated by the present disclosure are epoxies, polyurethanes, phenolic resins, amino resins, polypropylene, polyethylene (PVC), and others known to artisans. Examples of thermoplastic resins include bismaleimides, such as BMI and polyimides, polyamides, and others known to artisans. Reinforcement members may be carbon, S-glass, E-glass, aramid, Kevlar and others suitable or commonly used in the art as reinforcement members 115 in composites. Composite lamina 116, which may take the form of tapes, weaves, or fabrics, is formed by curing reinforcement members 115 into composite matrix material 114 and is well known in the art.

According to the teachings of an embodiment of the present disclosure, partially or fully cured composite members or wood products are subjected to either pre- or post-tensioning forces via pre-stressing members, including: prestressed synthetic fibers, fabrics, tapes, weaves, laminas, laminates, cables, rods, netting, or combinations thereof, and other pre- and post-tensioning methods common to a person of ordinary skill in the art, including thermal effects, electric polarity and the influence of magnetic fields. The pre-stressing member may be made of steel, aluminum or other metals; natural fibers, such as flax, kenaf, hemp, or wood; synthetic fibers, such as E-glass, S-glass, aramid, carbon, graphite, silicon carbide, aluminum, boron, ultrahigh molecular weight polyethylene, polybenzoxazile (PBO), nylon, vectran, polybenzimidizole (PBI), vectra, dyneema, certran, and spectra; or other suitable pre-stressing implements known to those skilled in the art. Additionally, pre-stressing members may consist of materials responsive to thermal shrinkage effects during or after manufacturing, shape memory alloys, and materials that are responsive to changes in temperature, electrical impulse or magnetic field.

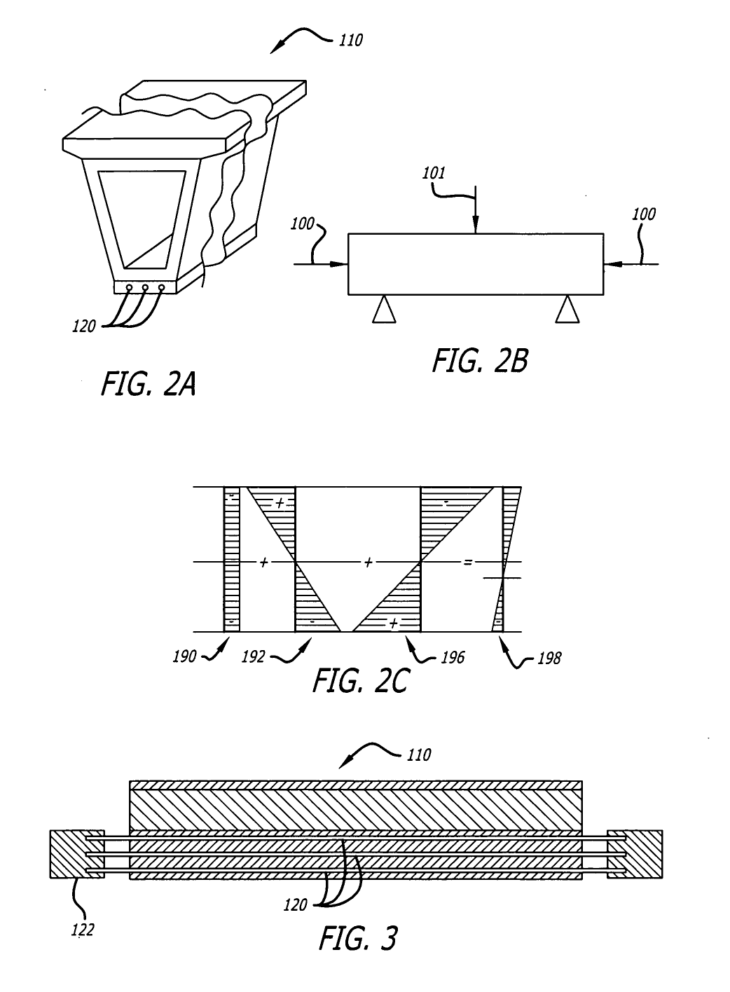

FIG. 2A demonstrates an embodiment of a typical prestressed composite member 110. Composite member 110, as represented in the exemplary embodiment of FIG. 2A, is a structural member. Within composite member 110 is at least one pre-stressing member 120. In the exemplary embodiment, the at least one pre-stressing member 120 is a cable; but, in practice, it may take many forms including rods, netting fabric, weave, tape, laminate or combination of those elements. Pre-stressing members 120 may be made of materials that are well known to those skilled in the art. Although illustrated in the exemplary embodiment, as plural pre-stressing members 120, the present disclosure does not rule out the use of a single pre-stressing member 120.

As demonstrated in FIG. 2A, at least one pre-stressing member 120 is eccentrically placed in prestressed composite member 110. Depending on the net or desired stress profile, the pre-stressing elements 120 may be located in various locations within composite member 110. The present disclosure contemplates eccentric placement, concentric placement or a combination of both types of placements. Additionally, where more than a single pre-stressing member 120 exists in composite member 110, each pre-stressing member 120 may be positioned in independent locations and orientations with respect to the composite member's central axis and with respect to each other.

FIG. 2B shows an embodiment of a side view of a typical prestressed composite beam 110 that is simply supported, supplemented by compressive force 100 on the extreme ends of the beam, and subject to normal force 101 on the upper surface at the midpoint of the beam. In this scenario, anchored prestressed elements attempt to return to a state of lower potential energy and, as a consequence, impart compressive force 100 on the composite member, which results in compressive stresses in the composite member. Further, the eccentric location of compressive force 100, below the neutral axis of the composite member, generates a moment, which produces additional stress in the composite members. Finally, the presence of normal force 101 on the upper surface of the simply supported composite member precipitates compressive stresses on the upper surface of the composite member and tensile stresses on the lower surface of the composite member.

A stress profile for an embodiment of composite member 110 of FIGS. 2A and 2B, is shown in FIG. 2C which illustrates the stress distributions along the depth of prestressed composite member 110 In the stress profile, compressive stresses are represented by a “−” sign and tensile stresses are represented by a “+” sign.

The impact of the pre-stressing process may be visualized by considering the deformation of a prestressed composite beam 110 subject to a dead or static load. If the prestressed composite beam is supported on its ends and the load is applied vertically downward at the mid-section, as in FIG. 2B, several simultaneous phenomena will take effect, as presented in FIG. 2C. A uniform compressive stress 190 will be created along the cross section of the beam, due to the action of the pre-stressing force created by pre-stressing elements 120. The eccentricity of the prestressing element(s) 120 will force the beam to deflect upward creating maximum tensile stresses 192 at the extreme upper surface of the beam and maximum compressive stresses 192 at the extreme lower surface of the beam. Upon the application of the external concentrated downward force or load, the beam will deflect downward creating an opposite state of stress, where maximum tensile stresses 196 occur in the extreme lower surface of the beam and maximum compressive stresses 196 occur in the extreme upper surface of the beam. When these three individual stress effects are combined or superimposed, much lower net stresses 198 are generated along the depth of the member, which suggests that the prestressed composite member has the capacity to carry additional load due to the presence and affects of pre-stressing. Further, a similar prestressed beam may utilize the above technology to satisfy the original load carrying requirements of the beam with fewer reinforcements, which would ultimately reduce the final cost of the composite member. Depending on the application and materials utilized, the value of net stresses may be adjusted by changing the amount of prestressing force and/or the location and the orientation of the prestressing elements.

The introduction of eccentric pre-stressing elements to of the composite structure has the additional benefit of minimizing stresses at the mid span of the beam or the member. This reaction has a positive effect on the long-term deformation and strength of the composite member by increasing the ability of the member to resist creep deformation and creep rupture, which are functions of stress level. Thus, eccentric pre-stressing decreases the net stresses in the composite member, lowers creep deformation and consequently lowers the possibility of failure due to sudden creep rupture of the member.

Referring to FIGS. 2A, 2B and 2C, compressive stress 190 represents the stress generated in the composite member due to the application of mechanical pre-stressing element 120 directly to composite member 110. In the exemplary embodiment, pre-stressing member 120 is pre-tensioned. After fixing pre-stressing member 120 with a tension retention device, such as mechanical anchors, grout, or by a method of curing, pre-stressing element 120 attempts to revert to an un-tensioned state, which imparts a compressive force on composite member 110 and generates compressive stress 190 over the whole cross section of composite member 110.

Calculated eccentricities in the placement of at least one pre-stressing member 120 induce stresses represented by secondary stress profile 192 in FIG. 2C. Here selection of the grade and skew angle of the eccentricity can be automated so that the resulting stress state is predicted and accounted for in composite member performance. When at least one pre-stressing element 120 is applied eccentrically, for example below the centroidal axis as in FIGS. 2A, 2B, and 2C both a compressive stress and a varying stress due to counterbalance moment are induced in composite member 110. The compressive effect of the eccentricity of pre-stressing member 120 is more pronounced near pre-stressing member 120, and decreases as a function of increasing distance from pre-stressing member 120. Similarly, with increasing distance, the tensile stresses 192 of the counterbalance moment become more pronounced, while the compressive stresses 192 of the counterbalance moment decline. Thus, in addition to the initial compressive stress 190, pre-stressing member 120 induces tensile stresses 192 on the upper portion of composite member 110 and compressive stresses 192 on the lower portion of composite member 110.

Inducing counterbalance moment is useful when load is applied opposite to the counterbalance moment or when constructing a cantilevered member such as a modular bridge section or aircraft wing. When a load is applied on top of prestressed composite member 110, for example, the net result of eccentric application of pre-stressing members 120 is decreased net deflection because the stresses induced by the load are resisted by the pre-stressing and the natural strength of the structural member. Thus, by eccentrically pre-stressing composite member 110, greater span-to-depth ratios are possible.

FIGS. 2A, 2B, and 2C demonstrate the net effect on the stress profile of a mechanically, thermally, or thermo-mechanically induced prestressed composite member 110. If composite member 110 was not subjected to a dead weight or an external load, the net state of stress would be due to the compression force of the at least one pre-stressing member 120 and counterbalance moment from the eccentricity of the placement of the at least one pre-stressing member 120. Using the teachings of the present disclosure, customizations of the net stress state are possible depending on the anticipated loads exerted on prestressed composite member 110. For example, customization may involve a reduction or variation in eccentricity or the application of simultaneous pre-stressing in two or more directions. These changes would be undertaken to enhance the performance of the composite member and, in one specific case, increase the amount of tensile stress that composite member 110 may resist before failure.

Referring again to the exemplary embodiment of FIGS. 2A, 2B, and 2C, prestressed composite member 110 becomes a stronger construction material due to the presence of pre-stressing elements 120, thereby overcoming many of the prior limitations commonly associated with composite structural members. When a live or dead load is applied, the forces induced by the load must overcome both the inherent strength of the composite and the added strength imparted due to pre-stressing before a failure of the construction material. Indeed, in the exemplary embodiment the load must overcome the counterbalance moment induced by eccentric placement of pre-stressing members 120, followed by overcoming the compressive force imparted to prestressed composite member 110, and finally the inherent strength of composite member 110 before the exemplary simply supported prestressed composite member fails.

Focusing on FIG. 2C, the third stress profile 196 represents an example of the stresses induced by a mechanical, thermal, or thermo-mechanical load on exemplary composite member 110 in FIG. 2A and FIG. 2B. In the current example, the position, direction and magnitude of the mechanical, thermal, or thermo-mechanical load on prestressed composite member 110 tends to induce compressive stresses 196 on the upper surface of composite member 110 and tensile stresses 196 on the lower surface of composite member 110. These stresses, as expected, are directly opposite to the stresses induced by the pre-stressing element 120, which is designed and engineered to produce the desired counteracting affect to the external mechanical, thermal, or thermo-mechanical load or deadweight applied to composite member 110. While the current disclosure discusses the impact of pre-stressing on a member subjected to a single load, the methodology is not limited to single loads or single pre-stressing elements. The methodology is robust and can handle the impact of multiple mechanical, thermal, or thermo-mechanical load cases of varying magnitude, location, direction and orientation on a composite member strengthened or stiffened by multiple sets of pre-stressing elements of varying magnitude, location, direction and orientation.

The fourth stress profile 198 in FIG. 2C represents the sum stresses or net stresses on the exemplary pre-stressed composite member 110 while carrying live or dead load. By adding (1) pre-stress and (2) by placing pre-stressing members 120 eccentrically, composite member 110 may bear higher stresses and support larger loads without failing. The net result of pre-stressing causes prestressed composite member 110 to have a compressive stress when unloaded that must be overcome, in addition to the inherent strength of composite member 110, before failure of prestressed composite member 110 occurs.

Although eccentric placement of pre-stressing members 120 in general is well documented, the present disclosure contemplates using the principles of eccentric placement of pre-stressing members 120 to create customized stress profiles in composite materials. The combination of the choice of composite matrix material 114 and reinforcement members 115 for composite member 110 and the placement of pre-stressing members 120 in, around and over composite member 110 allow for individually tailored stress profiles to be created as part of the inherent properties of the improved composite. Variations in the choice of material forming pre-stressing element 120, the number of pre-stressing members 120, and the placement of pre-stressing member 120 allow for further customization and fine tuning of desired stress profiles.

Thus, the present disclosure presents a method in which the stress profiles of composites may be modified for specific uses. As a result, fewer traditional reinforcements 115 will be required to be embedded in the matrix of the original design of composite member 110, which will reduce the total cost of fabrication of composite member 110, while simultaneously providing an optimized structural material for a selected task. Moreover, the present disclosure contemplates the design and fabrication of customized composites that may be engineered specifically for the unique forces and conditions that the particular composite member will withstand, depending on the combination of composite matrix material 114, reinforcement members 115, and pre-stressing members 120. Additionally the placement or eccentricity of pre-stressing members 120 allows for further customization. In some embodiments, the pre-stressing members 120 and reinforcement members 115 are the same.

As previously discussed, both creep deformation and creep rupture are affected by the stress level. Pre-stressing composite member 110 with pre-stressing member 120 decreases the overall stresses on composite member's 110 reinforcement members 115, thus reducing creep deformation and lessening the possibility of failure due to creep rupture. Consequently, the number of reinforcement members 115 that must be used in order to prevent creep deformation and eventually creep rupture are reduced because of the additional strength imparted by pre-stressing. In this manner, pre-stressing composite member 110 provides a method to reduce cost for composite members 110 by reducing the volume fraction of reinforcement members 115 without sacrificing strength, stiffness, long-term viability of the composite member 120 and safety.

The present disclosure teaches a more efficient construction of composite members 120. By using pre-stressing laminate fibers, pre-tensioned prefabricated rods, pretensioned prefabricated cables, fabrics, weaves, tapes, laminates or combinations thereof, the strength, stiffness, impact resistance and toughness of composite member 110 is increased. An embodiment of the present disclosure is illustrated by the embodiment represented in FIG. 3 demonstrating an efficient and structurally reliable method for increasing the load-carrying capacity and stiffness of composite member 110. In the exemplary embodiment of FIG. 3, pre-stressing members 120 strengthen composite member 110. Each pre-stressing member 120 can be applied internally, externally or in a manner that combines both approaches. Each pre-stressing element 120 may consist of prestressed fibers, fabrics, weaves, tapes, laminates, cables, rods, shape-memory alloys, and or combinations thereof. The prefabricated cables, prefabricated rods, fabrics, weaves, tapes, and laminates may be made from standard materials or composite materials, depending the desired characteristics of the final product.

According to the exemplary embodiment of FIG. 3, each pre-stressing member 120 is embedded within or housed in premade channels in composite member 110, this process may be implemented both internally and externally. Tension retention devices 122 preserve the tension of each pre-stressing member 120 by preventing each pre-stressing member to fully return to an untensioned state after pre- or post-tensioning. Tension retention device 122 may utilizes mechanical process, such as adhesive grouting or mechanical end anchoring, or may employ thermal effects or other techniques known to the art. Tension may also be retained by bonding and curing tension retention device 122 into FRP composite matrix 116 or FRP composite member 110.

In the exemplary embodiment of FIG. 3, pre-stressing forces are applied to cured composite member 110 by pre-stressing members 120, extended along the length of composite member 110. In the exemplary embodiment, pre-stressing members 120 are cables or rods made from a suitable material such as shape memory alloys, metals, and natural or synthetic fibers including but not limited to carbon, E-glass, S-glass, and Aramid. Many other equivalent pre-stressing members 120 are expressly contemplated as would be known to a person of ordinary skill in the art. The present disclosure contemplates pre-stressing members 120 extended along the length or width of non-circular cross sections and hooped for circular and cylindrical cross sections through prefabricated channels. Such internal, external or combined pre- and post-tensioning techniques are well known by those skilled in the art.

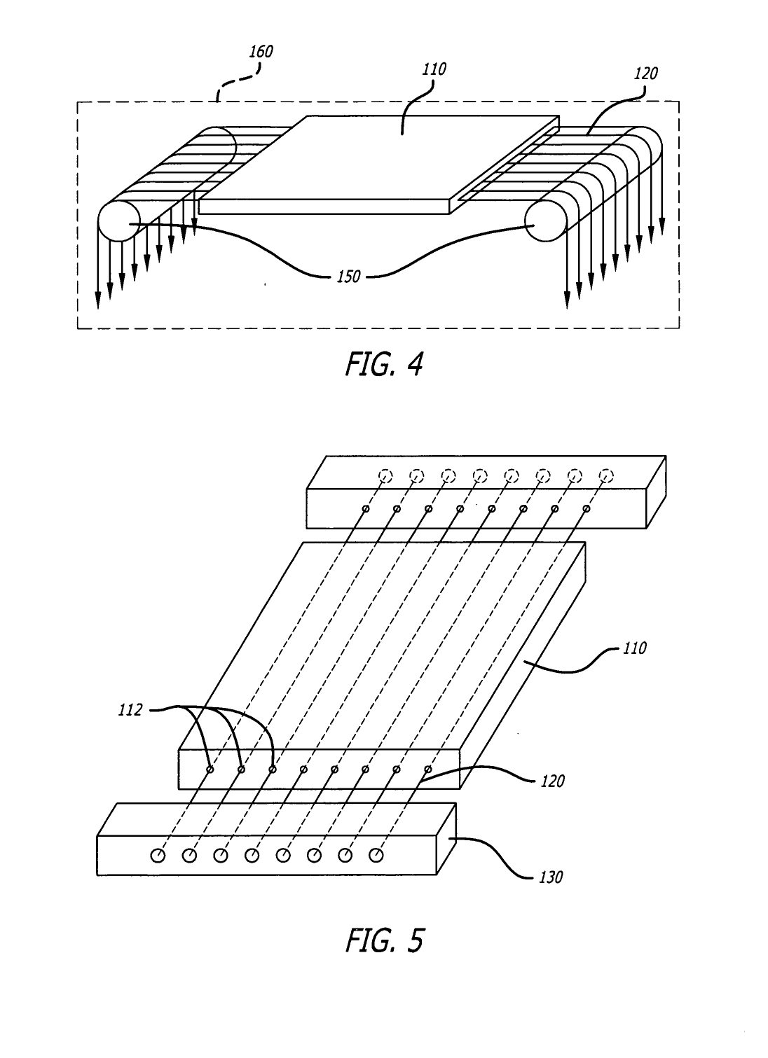

FIG. 4 demonstrates an embodiment of a method of pre-stressing composite member 110 by pre-tensioning of plurality of pre-stressing members 120 during the process of curing composite member 110. The process occurs in curing chamber 160. During the process of curing composite member 110, pre-stressing members 120 are placed into pre-cured composite member 110 and tensioned by pulling pre-stressing members 120 over heated drums 150, for example. Other pretensioning methods are also suitable for use in curing chamber 160 as would be known to a person of ordinary skill in the art. Embedding pre-stressing members 120 into composite matrix 116 dispenses with the need for additional tension retention devices 122, as the cured composite matrix 116 serves as the tension retention device 122. Composite member 110 cures with pre-stressing members 120 embedded in cured matrix 116 bonding pre-stressing members 120 into matrix 116 of cured FRP composite member 110. When pre-stressing members 120 are released after the composite member is cured, composite member 110 receives a net compressive force imparted from pre-stressing members 120. After complete curing of composite member 110, the ends of the prestressed cables or rods are released and the pre-tensioning forces are transferred to composite member 110. This process may be accomplished using various methods of manufacturing composites including RTM, SCRIMP, VARTM, pultrusion, vacuum bagging, autoclave cure, compression molding, filament winding, and other methods common to those skilled in the art; and is applicable to ceramic composites, metal matrix composites and organic composite systems.

FIG. 5 demonstrates an alternative embodiment of the process of pre-stressing composite material 110 after it is cured. Pre-stressing members 120 are pre-tensioned applied to composite member 110, for example, through premade channels, and restrained at their ends by, for example, anchoring on stressing beds or by affixing pre-stressing members to abutments which prevent pre-stressing members 120 from returning to a relax state. According to the process of the exemplary embodiment, composite member 110 is fabricated without pre-stressing members 120 integrated into composite member 110. Rather, composite member 110 is cured with pre-stressing channels 112 through which pre-stressing members 120 may be inserted after completion of the curing process. Once inserted through pre-stressing channels 112, pre-stressing members 120 are thereafter subjected to tensile forces by, for example, calibrated jacks, load cells or being stretched over heated drums (see FIG. 4). Pre-stressing members 120 are temporarily anchored with temporary anchorage 130 for example abutments, stressing beds, or other suitable anchors while the pre-stressing forces are transferred to the composite member. Permanent transfer of the force from pre-stressing member 120 to composite member 110 is accomplished with tension retention device 122. Tension retention device 122 may be grouting with a compatible resin, by using mechanical end anchorage devices, or other methods well known to those skilled in the art.

Also disclosed in the present disclosure is a method of optimally using prestressed composite members. According to the teachings of the method, custom prestressed composite materials may be customized for specific loads, allowing for a reduction of costs associated with traditional building methods by choosing building materials with load characteristics appropriate for the intended task. Indeed, customized prestressed composite members may be made with a variety of composite matrices 116, reinforcement members 115, and pre-stressing members 120 based on the weight, strength, stiffness, and cost requirements of the desired building material. Moreover, the composite matrix material 114 may be chosen based on the environmental conditions to which it will be subjected, durability requirements, and cost. For example, composite members 110 that will be subject to salt water and wave action may have a completely different force profile from composite members that will be utilized as the floor boards of a house.

Thus, an easy and simple methodology is disclosed that improves and allows for customization of the stiffness, strength, toughness and deflection of building materials resulting from applied service loads, including both dead and live loads, as well as other loads due to impact, wind, wave, and seismic activity. Using this process, it is possible to have zero net deflection relative to the horizontal or vertical axis of the member, by introducing initial negative deflection to the composite member via an eccentric pre-stressing force. In this case, the location, relative to the centroidal cross-section, and the magnitude of the pre-stressing force may be adjusted such that the initial elastic line produces counter deformation, which can be up, down, left or right, i.e. positioned in an optimized manner according to the goals of the designer. Consequently, upon the application of the expected service load, the maximum deflection is calculated and adjusted such that the maximum deflection with respect to the centroidal axis is zero.

Once the composite matrix material 114 and reinforcement member 115 selections are made, a customized force profile may be designed for specific applications of the pre-stressing member 120. The specific lay-up or design may be selected for the composite member 110 addressing the unique characteristics and requirements for the specific intended use of pre-stressing member 120. Indeed, the benefit of using pre-stressing member 120 as taught by the present disclosure is the ability to customize the stress profiles of structural and non-structural materials to specific purposes using a combination of selected variations in FRP composite matrix material 114, reinforcement member 115, fiber architecture, and pre-stressing pattern and intensity, including placement of the pre-stressing members 120. Consequently, for each job to be done, materials specifically appropriate for the task may be selected.

For example, the forces exerted on floorboards are different than the forces exerted on the load bearing walls in a house. Floorboards need only resist flexural forces. Conversely, the boards comprising the load bearing wall needs to be stiff in multiple directions due to the varied forces acting upon them, including the weight of the roof, wind, and seismic activity. Thus, a builder could save money by selecting FRP composite materials with a suitable force profile for flooring, while incurring additional cost for stronger and stiffer materials used for the load bearing walls only as stronger materials are called for. The examples that follow demonstrate the utility and flexibility of selecting appropriate characteristics in composite materials, and illustrate the wide range of applications taught by the techniques of the present disclosure.

### EXAMPLE 1

Pre-stressing elements may be applied to traditional structural components such as plywood, oriented strand board (OSB) and other wood-based products, imparting to the plywood and other materials greater strength, added stiffness, increased toughness and improved insulation qualities compared to non-pre-stressed wood-based materials. These improvements, which do not require changes to traditional building practices, offer construction professionals greater flexibility when responding to live loads, severe wind loads, and ground accelerations generated by earthquakes.

For wood structures, shear walls are vertical systems that consist of studs, joists, sheathing and fasteners. In most applications, they are designed to receive lateral forces from horizontal diaphragms (floors and ceilings) and transmit the forces to the ground. The forces acting on shear walls are predominantly shear forces. Generally, shear walls must be strong, rigidly connected to each other, and tightly connected to horizontal diaphragms in order to safely transfer lateral forces to the ground.

Floor diaphragms and roof diaphragms are horizontal systems that incorporate joist, beams, rafters, sheathing, and fasteners to create wholly integrated units that support vertical forces associated with, for example, appliances, furniture, people, and snow. They also transmit forces from wind pressure and earthquake accelerations to supporting shear walls. The general construction of floor and roof diaphragms comprise appropriately spaced framing members that are covered with sheathing and fastened together. In many cases, joists and rafters are oriented to maximize the moment of inertia in order to improve resistance to flexure.

In the case of shear walls and diaphragms, sheathing is used to provide the lateral support between structural members. If incorporated into this methodology, prestressed composite wood products may be used in place of traditional sheathing with improved performance due to increased rigidity and stability. Consequently, as a result of pre-stressing, shear walls built with composite reinforced “prestressed” plywood are better able to resist the forces of shear and carry vertical loads, reduce the likelihood of buckling, and, depending on the ultimate design, may result in more efficient use of materials to accomplish the same task as compared to traditional plywoods.

Similarly, diaphragms built with prestressed composite wood products impart increase rigidity for flexural strength and span, are less likely to wrinkle, and are more efficient at transmitting forces than traditional counterparts. Additionally, builders realize increased performance with favorable tradeoffs in weight and cost when using prestressed composite wood products.

In the case of an earthquake, the floor acts as a rigid diaphragm, transferring the lateral earthquake forces at the connection of the floor to the exterior shear walls. In the case of earthquakes, a building is initially at rest prior to the seismic event. Once the earthquake arrives, the building is suddenly accelerated laterally by horizontal ground motion. The motion is transferred to the structure through its foundation. Consequently, forces develop in the building that attempt to resist the motion transferred from the foundation.

The structural members of the building, bridge or other structural asset resist the forces imparted by the seismic activity. Accordingly, the diaphragms serve to transmit seismic forces from and to shear walls and frames, which act as lateral force-resisting elements. Thus, the diaphragms, shear walls, joints, frames, and foundations in wood buildings must have sufficient strength and stiffness, which can be achieved by pre-stressing, to resist the forces imparted by the seismic activity and transmit the forces back to the ground.

Consequently, additional strength, stiffnesses, toughness, and rigidity in the building materials serve to resist collapse and act as a conduit for the delivery and removal of forces through the structure and into the foundation. Composite pre-tensioned prestressed plywood, as taught in the present disclosure, serves to deliver a lightweight and cost effective alternative to traditional sheathing without distorting the actual building design, delaying building fabrication, or disturbing the normal building usage.

Similarly, the impact of severe wind load on buildings, for example from hurricanes, has an effect that is equivalent to the response due to seismic loads. Severe wind loads often induce lateral forces in structures that must be transmitted to the ground. Consequently, forces that are delivered to the top and sides of a structure must be transmitted to the ground by structural materials including the frame, connecting materials, anchorage systems, diaphragms, and sheer walls. The shear walls, in particular, come under tremendous pressure to bend and twist due to the forces induced by the wind and as a result of impact. Here, pre-stressing may be used to improve performance of individual components, which may dramatically strengthen and or stiffen the overall structure.

Pre-stressing also improves performance in response to wind loads. Wind velocity varies with height and increases as a function of height above the ground. Wind velocity at ground level slows because of surface drag. Similarly, wind slows due to friction with the walls and roofs of buildings. However, wind passing by the sides of buildings accelerates in an attempt to resume its original speed. Thus, the windward wall receives pressure that pushes the wall inward, while the leeward wall receives a suction force, pulling the wall outward. Similarly, the windward roof slope generally receives pressure and an inward push, while the leeward roof slope always receives suction and an outward pull. The sidewalls that are parallel with the wind direction are pulled outward by suction force as the wind accelerates to rejoin the wind at the leeward side. The combination of these forces may lead to shear failure of a structure or the overturning of a system around a reference point. Consequently, the use of prestressed materials in the construction of a building increases the rigidity and strength of the building, helps to resist wind induced forces, and ensures the redirection of those forces into the ground.

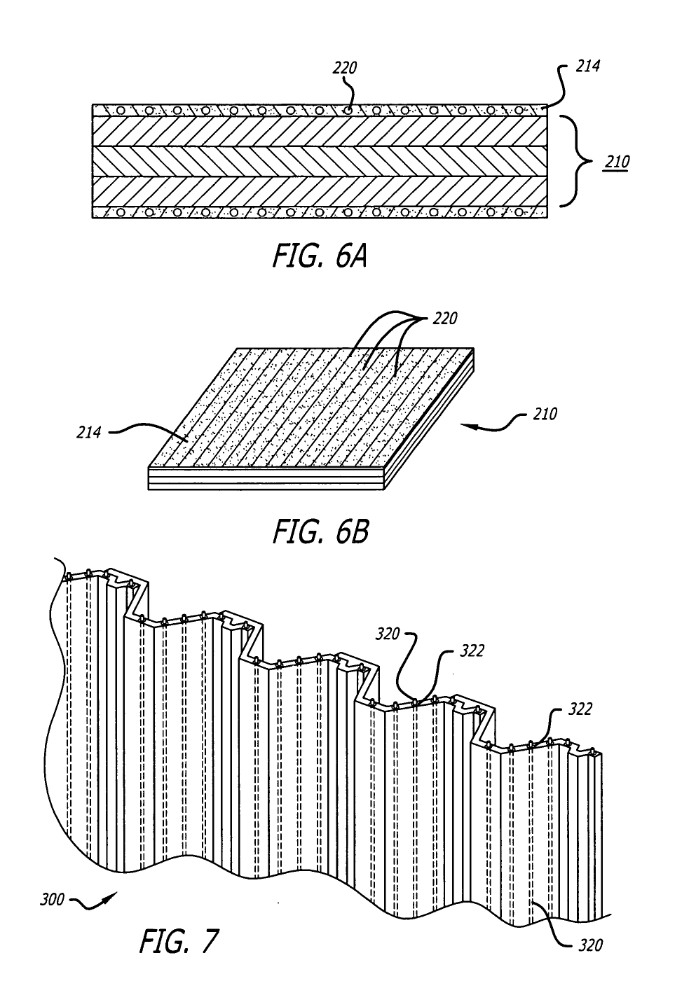

FIG. 6A demonstrates the principles of the present disclosure as applied to plywood. Plywood may be reinforced using pre-stressing members 220 such as carbon, E-glasses, glass, aramid, and other similar materials previously disclosed. These fibers or laminates can be applied as thin laminates 214, such as a cured epoxy resin or others disclosed herein or common in the art, to one side, both sides, between the plies of the plywood, or combinations thereof, in embodiments.

According to the exemplary embodiment show in FIG. 6A, pre-stressing members 220 is embedded in laminate 214 to two sides of plywood 210. Pre-stressing members 220, extend the length of the plywood as demonstrated in FIG. 6B. Pre-stressing members 220 are cured into laminate 214. Tension retaining devices may be used depending on the particular combination of pre-stressing member 220 and laminate 214, although may be unnecessary in many cases because pre-stressing members 220 are cured into laminate 214. The exemplary example shows pre-stressing member 220 as a prestressed rod or a prestressed wire embedded into laminate 214. Pre-stressing member 220 may be made from carbon, aramid, glued laminates, other types of wood products, S-glass, or E-glass prestressed netting or cloth cured into the laminate 214 and oriented such that the combination of laminate 214 and the fibers impart to the plywood a modified stress profile. As shown in FIGS. 5A and 5B, two of the outsides surfaces of plywood 210 are treated; however, the present disclosure contemplates applying an laminate 214 to only one outer side, between the plies of plywood 210 or any combination of outer sides and interior plies of the plywood.

Many combinations of reinforcement fibers 220 and laminate 214 materials may be used successfully depending on the desired stress profile. Cost savings may realized by using, lower grades of plywood 210 in building applications due to the increased strength and stiffness imparted by the laminate 214 and pre-stressing member 220, where a lower plywood grade would otherwise be unsuitable. Indeed, the present disclosure is suitable even where a specific force profile is not envisioned, but the end goal is to use stronger plywoods in terms of overall strength and stiffness.

Methods of applying the composite laminate 214 to plywood, oriented strand board (OSB) or other wood products 210 include vacuum assisted resin transfer molding (RTM) lamination, spray-molding, by heated drum (see FIG. 4), on a pre-stressing bed (see FIG. 5), or in other ways commonly known to those skilled in the art. Using RTM, for example, plywood 210 panels of different grades are laminated with different types of thin ply composites such as carbon and epoxy, E-glass and epoxy, aramid and epoxy and many others. Alternately in an embodiment where cost is an issue, spray-molding is relatively inexpensive and may be used for lower grades of composite reinforced plywood where E-glass fibers are embedded in composite laminate 214. Depending on the strength requirements and architectural constraints, composite laminates are applied either to a single side or the two sides of the structural plywood panel between plies, or combination of one or more sides and between one or more plies. Here prestressing may be achieved by variations in temperature related to curing of the materials or by exploiting micro-attachment properties of the sprayed on fibers.

Naturally, depending on the desired characteristics of the prestressed composite wood product 210, various choices can be made with respect to the combination of composite matrix material 114, reinforcement members 115, and prestressing member 220. In addition, selections related to used the percentage of surface area treated, the method of treatment, and the initial quality of the plywood, in order to achieve the desired force profile.

### EXAMPLE 2

The teachings of the present disclosure are also suitable for use as sheet pilings, sea fences, sound walls and other structures used in marine environments. Prestressed composites are well suited as pilings because of their high strength to weight ratio. Moreover, the stiffness of prestressed composites makes them easier to drive, allowing for the pilings to be driven to greater depths. Moreover, prestressed composite marine pilings give superior corrosion protection over steel pilings and are bore resistant over wooden pilings.

Prestressed composite pilings are well suited to marine environments. They are lightweight and provide improved corrosion resistance and better permeability than steel or wood pilings. Additionally, prestressed composite pilings do not suffer from rot, rust, and spall common in steel and wood pilings, and are unaffected by marine borers. Finally, prestressing the FRP composite piling provides for improved strength, stiffness, and allow for customized force profiles to be built into the piling.

Sheet piles are interconnected piles that form a continuous “wall.” As opposed to pile foundations, sheet piles are intended to resist lateral forces. They are used in many marine construction applications such as quays and harbors, locks and moles, bank reinforcements, and in non-marine applications such as retaining walls, bridge abutments, and foundation structures.

Outside of marine environments, piles are used as pile foundations. The purpose of a pile foundation is to transmit the load of a structure into the ground and, in the case of seismic activity, transmits loads laterally. Typically pile foundations are used with poor load bearing surface soil.

FIG. 7 represents an embodiment of the present disclosure useful as a prestressed composite sheet piling. Each pile may be used alone or in combination with other piles. As shown in FIG. 7, the configuration of pilings 300 is similar to other composite pilings common in the art. As further demonstrated in FIG. 7, each piling 300 may have one or more prestressing members 320. Depending on the placement of prestressing members 320, customized force profiles may be built for piling 300 depending on the anticipated stresses. The configuration of shape, physical dimensions, and interconnection of pilings 320 may take on many forms that would be well known to those skilled in the art. Prestressing members 320 may be anchored with tension retention device 322 in various ways common in the art, including grouting, end anchoring, or by curing prestressing members 320 into each pile 300.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of changing the stress profile of a composite member comprising the steps of:
(a) providing composite member; and
(b) providing at least one prestressing member;
wherein the prestressing member is used to prestress the composite member.

2. The method of claim 1, further comprising at least one tension retention device.

3. The method of claim 1, wherein the composite matrix material of the composite member is ceramic, metal, organic or polymer resin such as epoxy, polyurethane, phenolic resin, amino resin, polypropylene, polyethylene, bismaleimide, BMI, polyimide, and polyamide, metal, ceramic or organic compound.

4. The method of claim 1, wherein the at least one reinforcement member of the composite member is carbon, E-glass, S-glass, aramid, kevlar or combinations thereof.

5. The method of claim 1, wherein the prestressing member is either pre-tensioned or post-tensioned.

6. A kit of parts for making a prestressed composite member comprising:
(a) an composite matrix material;
(b) at least one reinforcement member; and
(c) at least one prestressing member;
wherein the composite matrix material and the at least one reinforcement member are used to form an composite member;
and wherein the prestressing member is designed to prestress the composite member.

7. The kit of claim 6, further comprising at least one tension retention device.

8. A method for reducing construction costs comprising the step of substituting traditional building materials with prestressed composite members.

9. The method of claim 8, wherein costs are reduced through a reduction in the quantity of building materials required for building structures or a reduction in components used to fabricate building materials that are required for building structures

10. The method of claim 8, wherein costs are reduced by selecting building materials with suitable stress profile for an intended application of the building material.

11. An improved plywood-like building material comprising prestressed plywood strengthened by use of a prestressing member, wherein the prestressing member is fixed to the plywood by a laminate, strand, cable, rod, fabric, or cloth on one side, two sides, between the plies of the plywood, or a combination thereof:
wherein the plywood-like building material is one of plywood, oriented strand board and other wood based panel and laminated product.

12. The improved plywood-like building material of claim 11, wherein the prestressing member may be made of steel, aluminum or other metal rods or cables; natural fibers, such as flax, kenaf, hemp, or wood; synthetic fibers, such as E-glass, S-glass, aramid, carbon, graphite, silicon carbide, aluminum, boron, ultrahigh molecular weight polyethylene, polybenzoxazile (PBO), nylon, vectran, polybenzimidizole (PBI), vectra, dyneema, certran, and spectra; or other suitable prestressing implements known to those skilled in the art, such as shape memory alloys and materials responsive to changes in temperature, electrical impulse or magnetic field.

13. The improved plywood-like building material of claim 11, wherein the laminate is embedded in epoxy resin.

14. The improved plywood-like building material of claim 11, wherein application of a prestressing member is used to customize the stress profile of the plywood, oriented strand board, or other wood based panel or laminated product.

15. The improved plywood-like building material of claim 11, wherein the prestress is accomplished by pre-tensioning or post-tensioning the prestressing member.

16. A method of reducing construction costs with an improved plywood-like building material comprising the step of treating a plywood-like building material with at least one prestressing member affixed to the plywood, oriented strand board, or wood based panel with a laminate layer:
wherein application of the at least one prestressing member to the plywood-like building material modifies the stress profile of the plywood-like building material.

17. The method of claim 16, wherein reduction of costs is accomplished by improving the structural qualities a lower grade of plywood-like building material, wherein the improved lower grade of wood products may be used for building purposes for which unimproved lower grade plywood-like building material would otherwise be unsuited.

18. The method of claim 16, further comprising the step of providing a plurality of improved plywood-like building materials in a plurality of stress profiles, wherein each improved plywood-like building material has a stress profile optimized for at least one specific application.

19. A method of making an improved plywood-like building material comprising the steps of:
(a) providing a wooden plywood-like building material;
(b) providing a laminating material;
(c) providing at least one prestressing member; and
(d) treating the plywood-like building material with the laminating material and the at least one prestressing member to form a laminate layer affixed to the plywood-like building material, wherein the laminate contains the at least one prestressing member; and
wherein the laminated plywood-like building material exhibits a modified stress profile.

20. The method of claim 19, wherein the laminating material is applied to the plywood-like building material using vacuum assisted resin transfer molding lamination or spray molding.

21. The method of claim 19, wherein the laminating material is applied between the plies of the plywood.

22. An improved composite piling comprising a fiber reinforced piling prestressed with a prestressing member, wherein the prestressing member modifies the stress profile of the composite piling.

23. The improved composite piling of claim 21, wherein the fiber reinforced piling exhibits increased stiffness.
